(19) United States
(12) Patent Application Publication
(10) Pub. No.: US 2026/0273875 A1
(43) Pub. Date: Sep. 17, 2026

(54) INFUSION MULTIMATERIAL ACTINIC SPATIAL CONTROL THREE-DIMENSIONAL PRINTING METHODS

(71) Applicant: Wisconsin Alumni Research Foundation, Madison, WI (US)

(72) Inventors: Andrew Jackson Boydston, Middleton, WI (US); Sarah Finnegan, Madison, WI (US)

(73) Assignee: Wisconsin Alumni Research Foundation, Madison, WI (US)

(21) Appl. No.: 19/564,377

(22) Filed: Mar. 12, 2026

Related U.S. Application Data
(60) Provisional application No. 63/771,139, filed on Mar. 13, 2025.

(51) Int. Cl. B29C 71/00; B29C 64/129; B29K 33/00; B29K 105/00; B33Y 10/00; B33Y 40/20; B33Y 70/10

(52) U.S. Cl. CPC B29C 71/0009; B29C 64/129; B29K 2033/08; B29K 2105/0002; B29K 2995/0005; B33Y 10/00; B33Y 40/20; B33Y 70/10

(57) ABSTRACT

Provided are methods for fabricating a multimaterial object which comprise fabricating an object comprising a first region and a second region, the first region and the second region differing in their swelling behavior in an infusion solution comprising a swelling solvent and an infusion material dissolved therein; exposing the fabricated object to the infusion solution to form an infused fabricated object; and removing the swelling solvent from the infused fabricated object to form a multimaterial object comprising the first region, the second region, and the infusion material, wherein more infusion material is distributed throughout one of the first region and the second region than the other. The multimaterial objects are also provided.

### CROSS-REFERENCE TO RELATED APPLICATIONS

The present application claims priority to U.S. provisional patent application No. 63/771,139 that was filed Mar. 13, 2025, the entire contents of which are incorporated herein by reference.

### REFERENCE TO GOVERNMENT RIGHTS

This invention was made with government support under N00014-23-1-2499 awarded by the NAVY/ONR. The government has certain rights in the invention.

### BACKGROUND

Additive manufacturing (AM), also known as 3D printing, refers to a number of technologies for fabricating three-dimensional (3D) objects based on digital data representing the 3D objects. The digital data is broken down into a series of two-dimensional (2D) cross-sections and the 3D object is fabricated layer-by-layer. There are a number of 3D printing technologies that have been developed depending upon the type of material, e.g., polymeric (resin) materials and metal materials. However, there have been challenges in the development of techniques for fabricating objects that are composed of both types materials.

### SUMMARY

Provided are methods for the fabrication of multimaterial objects, including those composed of highly disparate classes of materials, e.g., polymers and metals. The methods are based on the selective infusion of desired materials into specific regions of a fabricated object, e.g., 3D resin objects fabricated by an additive manufacturing techniques, with high spatial resolution. The methods enable fabrication of a broad range of composite objects, i.e., multimaterial objects, including electrical circuits composed of a network of conductive regions electrically isolated from one another by insulating regions.

The present methods are illustrated by reference to an Example, below which describes an embodiment referred to herein as infusion multimaterial actinic spatial control additive manufacturing (iMASC-AM). The method uses dual wavelength light projection to create distinct material regions within a single printed part, the different material regions having disparate affinity toward infusion of dissolved materials. The Example demonstrates the versatility of iMASC-AM with the infusion of organic dyes, silicone resins, and metal salts for patterned optical, mechanical, and conductive properties, respectively. Notably, mild thermal post-processing after infusion was found to reduce silver salts, leading to patterned combinations of electrically conductive and insulating domains and allowing for fabrication of functional circuits from a single print. The iMASC-AM method enables the creation of a wide variety of chemically diverse multimaterial parts with materials properties combinations that are generally inaccessible through vat photopolymerization (VP).

In embodiments, a method of fabricating a multimaterial object comprises fabricating an object comprising a first region and a second region, the first region and the second region differing in their swelling behavior in an infusion solution comprising a swelling solvent and an infusion material dissolved therein; exposing the fabricated object to the infusion solution to form an infused fabricated object; and removing the swelling solvent from the infused fabricated object to form a multimaterial object comprising the first region, the second region, and the infusion material, wherein more infusion material is distributed throughout one of the first region and the second region than the other.

In embodiments, a multimaterial object comprises one or more electrically conductive regions comprising a first type of polymeric network and an electrically conductive material distributed throughout; and one or more electrically insulating regions comprising a second type of polymeric network.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1B show a schematic illustration of the iMASC AM (infusion multimaterial actinic spatial control additive manufacturing) process according to an illustrative embodiment. (FIG. 1A) From a single resin vat, radical polymerization can be initiated though visible light (405 nm) irradiation to yield elastomeric, acrylate-dominant regions (right half of resin object), while cationic polymerization can be initiated through UV light (365 nm) irradiation to yield stiff, epoxide-dominant domains (left half of resin object). (FIG. 1B) Schematic showing the subsequent step of selective infusion of a desired material (infusion material) into the acrylate-dominant region of the printed resin object. FIGS. 2A-2D illustrate fusion behavior. (FIG. 2A) Gravimetric swelling data for acrylate- and epoxide-dominant parts in various solvents (isopropanol, IPA; tetrahydrofuran, THF). Error bars represent standard deviation. (FIG. 2B) An image of a rhodamine 6G-infused smiley face. (FIG. 2C) An image of a Cu(NO₃)₂-infused honeycomb patterned part. (FIG. 2D) Images of a CAD file (top), control (left) and silicone-infused multimaterial part (right) being stretched with 100 g and 200 g weights, respectively.

FIGS. 3A-3E. Mechanical Analysis of Silicone-infused parts. (FIGS. 3A-3C) Mechanical analysis of silicone-infused epoxide- and acrylate-dominant parts. Error bars represent standard deviation. (FIGS. 3D-3E) Tensile analysis curves representative of the average mechanical performance of control and silicone-infused epoxide- and acrylate-dominant parts.

FIGS. 4A-4E. Silver Trifluoroacetate (AgTFA)-Infused Parts. (FIG. 4A) Gravimetric analysis of epoxide- and acrylate-dominant parts over a range of AgTFA solution concentrations. Error bars represent standard deviation. (FIG. 4B) Analysis of residual mass at the surface and interior of acrylate-dominant parts as determined through TGA over a range of AgTFA solution concentrations. (FIG. 4C) AgTFA-infused multimaterial part after infusion (left) and after subsequent thermal reduction (right). (FIG. 4D) CAD file (left) and thermal image (right) of a thermally reduced, AgTFA-infused part placed on a cold pack after removal from a hot plate. (FIG. 4E) CAD file (left), AgTFA-infused, thermally reduced part (center), and AgTFA-infused, thermally reduced part completing a circuit through the acrylate-dominant domain only (right, top). The epoxide-dominant domain does not complete a circuit (right, bottom).

FIG. 5 shows an illustrative heating profile for thermal treatment to convert silver cations to silver metal.

FIG. 6 is a flow chart schematically illustrating various embodiments of the present methods.

### DETAILED DESCRIPTION

Methods of fabricating multimaterial objects are provided. In an embodiment, such a method comprises an initial step of fabricating an object, the object comprising at least two regions (e.g., a first region and a second region) that differ in their swelling behavior in an infusion solution comprising a swelling solvent and an infusion material dissolved in the swelling solvent. Next, the fabricated object is exposed to the infusion solution. Due to the different swelling behaviors of the first region and the second region, the exposure step results in a greater amount of the infusion material being incorporated into one of the first and second regions than the other. This step, which is further described below, achieves selective adsorption of the swelling solvent and selective infusion of the infusion material into the fabricated object. Next, the swelling solvent is removed from the infused fabricated object. This step provides a multimaterial object comprising the at least two regions and the infusion material, wherein a greater amount of the infusion material is distributed throughout one of these two regions than the other. The method may include an additional step (e.g., thermal treatment) to convert the infusion material (e.g., metal ions) within the multimaterial object to a different form (e.g., reduced metal atoms).

The fabricated object may comprise multiple first regions (i.e., a set of first regions) and multiple second regions (i.e., a set of second regions), wherein the set of first regions is characterized by a different swelling behavior than the set of second regions. The fabricated object may have more than two types regions (or sets thereof), e.g., first region(s), second region(s), third region(s), etc., wherein the regions (or sets thereof) each have different swelling behaviors from one another.

Regarding fabrication of the object, this may be accomplished by inducing chemical reactions (e.g., using light, heat, or both) between prepolymers within localized areas of a curable composition to form a polymeric network in these localized areas. This results in a plurality of localized polymeric network regions within the curable composition, including the at least two regions described above. Additional localized polymeric network regions may be formed simultaneously or sequentially, e.g., in a layer-by-layer fashion as in additive manufacturing techniques. The collection of localized polymeric network regions constitutes the fabricated object, e.g., a three-dimensional (3D) object, the shape and dimensions of which may be controlled by the technique used for inducing the chemical reactions as well as digital data corresponding to the desired fabricated object.

As noted above, at least two regions of the fabricated object are characterized by different swelling behaviors in the infusion solution. The phrase “swelling behavior” refers to absorption of the swelling solvent of the infusion solution into a particular region (or set of regions) of the fabricated object. As described in the Example, below, absorption may be measured using thermogravimetric analysis and quantified as a percent mass change of the region (or fabricated object) after exposure to the infusion solution as compared to that prior to exposure (i.e., (mass of region after exposure)/(mass of region prior to exposure)*100). Different swelling behaviors means that different regions exhibit different percent mass changes after the same exposure step. The magnitude of the difference in swelling behaviors may be quantified as a swelling ratio, i.e., (percent mass change of region exhibiting greater swelling)/(percent mass change of region exhibiting lesser swelling). In the present methods, the swelling ratio of at least two regions in the fabricated object is greater than one, although it can be desirable to maximize the swelling ratio. In embodiments, the swelling ratio of the at least two regions is at least 2, at least 3, at least 4, at least 5, at least 6, at least 7, or at least 8. This includes a range of between any of these values, including, from 2 to 15.

The difference in swelling behaviors is generally due to the at least two regions of the fabricated object having different chemical compositions from one another, including being composed of different types of polymeric networks. This is demonstrated in the Example below, showing that a polymeric network formed by polymerizing epoxide prepolymers swells substantially less in a variety of swelling solvents (i.e., absorbs substantially less of the swelling solvent) as compared to a polymeric network formed by polymerizing acrylate prepolymers. (See FIG. 2A.) Objects comprising different regions composed of these different types of polymeric networks may be fabricated using the techniques described herein and a single (i.e., one) curable composition comprising components for synthesizing the different types of polymeric networks. This includes a curable composition comprising a first type of prepolymer (for forming a first type of polymeric network) and a second type of prepolymer (for forming a second type of polymeric network), wherein the first and second types of prepolymers are different from one another, i.e., have different chemical compositions. However, in embodiments, “different types of polymeric networks” encompasses two polymeric networks composed of the same prepolymers but different degrees of crosslinking.

The types of prepolymers (and their relative amounts) are selected to ensure the different swelling behaviors as described above, including a desired swelling ratio. Selection also depends upon the desired application for the multimaterial object. Otherwise, a variety of prepolymers may be used and in various relative amounts. The term “prepolymer” refers to molecules from which a polymeric network is derived, including monomers and/or oligomers which undergo chemical reactions to form a polymer chain. The term “prepolymer” also encompasses individual polymer chains which become crosslinked through other chemical reactions. Thus, “polymeric network” encompasses both uncrosslinked polymer chains and crosslinked polymer chains and “prepolymer” encompasses the repeating units of such polymer chains.

Suitable prepolymers include those for which the relevant chemical reactions are induced by heat as well as those which involve free radical polymerization reactions, cationic polymerization reactions, or anionic polymerization reactions. In embodiments, the prepolymers are those which form the following polymers: polyurethanes; polyepoxides; silicones; poly(meth)acrylates; poly(meth)acrylamides; vinyl polymers; polyvinylethers; polyvinylcarbazoles; polysiloxanes; polystyrenes; polythiols; polyesters; cyclo-olefin polymers, etc. Other illustrative prepolymers include those described in International Patent Publication WO 2018/057330; International Patent Publication WO 2023/288189; U.S. Pat. Nos. 12,138,853; and 11,597,145, each of which is hereby incorporated by reference in its entirety.

Other components are generally included in the curable composition, e.g., solvents (to solubilize or dissolve prepolymers), initiators (to generate free radicals/ions), catalysts (to control kinetics), crosslinking agents (to induce/participate in crosslinking reactions), inhibitors (to inhibit formation of free radicals/ions), and combinations thereof. Curable compositions as described in any of International Patent Publication WO 2018/057330; International Patent Publication WO 2023/288189; U.S. Pat. Nos. 12,138,853; and 11,597,145, may be used, each of which is hereby incorporated by reference in its entirety.

The at least two regions of the fabricated object having different swelling behaviors may be formed by exposing the localized areas of the curable composition to different conditions to generate the different types of polymeric networks in respective regions. The particular conditions depend upon the prepolymers being used and the technique used to induce chemical reactions between the prepolymers. However, by way of illustration, for additive manufacturing techniques using light to induce chemical reactions between prepolymers, the different conditions may include using different wavelengths of light, different illumination times, or both, in different localized areas of the curable composition. By way of further illustration, the Example below describes exposing localized areas of a curable composition comprising both acrylate prepolymers and epoxide prepolymers to light under different conditions. Specifically, 405 nm light and an illumination time of 15 seconds was used to polymerize acrylate prepolymers to form polyacrylate networks in localized areas of the curable composition and 365 nm light and an illumination time of 75 seconds was used to polymerize epoxide prepolymers to form polyepoxide networks in other localized areas of the curable composition. The Example, below, further describes the use of a single wavelength, 365 nm light, but shorter illumination times, to facilitate formation of polyacrylate networks and longer illumination times to facilitate formation of polyepoxide networks. The use of light under different conditions to generate different localized polymeric network regions is further described in International Patent Publication WO 2018/057330, which is hereby incorporated by reference in its entirety.

Further regarding the various regions of the fabricated object having different swelling behaviors, these regions may, but need not, consist of a single type of polymeric network (e.g., a polyacrylate network or a polyepoxide network). For example, a curable composition comprising both acrylate prepolymers and epoxide prepolymers may be exposed to conditions that favor polymerization of acrylate prepolymers over epoxide prepolymers, while still resulting in some polymerization of epoxide prepolymers. In such a case, the resulting region includes primarily polyacrylate, but may include some amount of polyepoxide. This resulting region may be characterized as being polyacrylate-rich or polyacrylate-dominant. Thus, a particular region of the fabricated object may be homogeneous, consisting of a single type of polymeric network or heterogeneous, comprising different types of polymeric networks, provided at least two regions in the fabricated object exhibit different swelling behavior as described above.

Other techniques may be used to form the fabricated object in the present methods, provided they achieve fabricated objects comprising the at least two regions exhibiting different swelling behavior as described above. This includes material jetting/inkjet printing as described in U.S. Pat. No. 12,138,853; use of photothermal materials/bases as described in U.S. Pat. No. 11,597,145; and the use of focused ultrasound as described in International Patent Publication WO 2023/288189, each of which is hereby incorporated by reference in its entirety.

As noted above, the present methods further comprise exposing the fabricated object to the infusion solution comprising the swelling solvent and the infusion material dissolved in the swelling solvent. Due to the different swelling behaviors of the at least two regions of the fabricated object, a greater amount of swelling solvent is absorbed into one of the first and second regions than another (i.e., the swelling solvent is selectively absorbed by the fabricated object). This, in turn, allows a greater amount of the infusion material to diffuse into the region exhibiting greater swelling as compared to the region exhibiting less swelling (i.e., the infusion material is selectively incorporated into the fabricated object). Selection of the swelling solvent and the infusion material depends upon the compositions of the first and second regions (e.g., the polymeric networks therein). Thus, selection may be based on achieving a specific swelling ratio as described above. In addition, desirably, the infusion material is selected to have a size that facilitates free diffusion throughout the selected region; to ensure dissolution in the swelling solvent under the conditions being used in the exposure step; and to be non-volatile under the conditions being used to remove the swelling solvent from the infused fabricated object. Illustrative swelling solvents include water; an alcohol (e.g., isopropanol or other short chain alcohols having from 2 to 6 carbon atoms); toluene; tetrahydrofuran; terpenes (e.g., limonene, carvone); or combinations thereof. Illustrative infusion materials include metal salts, dyes, metal oxides, and prepolymers such as those listed in Table 1 below, which also provides non-limiting applications for multimaterial objects which include such infusion materials. Other infusion materials which may be used include conductive materials that are not necessarily metallic such as conductive polymers (e.g., polyaniline, polythiophene) or prepolymers thereof and polymer electrolytes (e.g., polyacrylic acid sodium salt; sulfonated tetrafluoroethylene-based fluoropolymer-copolymers such as Nafion) or prepolymers thereof.

TABLE 1
Illustrative infusion materials and applications
for the resulting multimaterial objects.

| Infusion Material | Application |
|---|---|
| Silver (I) trifluoroacetate | Electrical/thermal conduction |
| Copper (II) nitrate | (after thermal post-processing |
| Nickel (II) nitrate | to convert metal ions to |
| Iron (III) nitrate | metal atoms) |
| Fluorescein, rhodamine B, | Optical imaging, fluorescence |
| pharmacophore | imaging, therapeutics |
| Iron (II, III) oxide | Magnetism |
| Zinc (II) oxide | Piezoelectricity |
| Silicones | Medical, structural, pre-ceramic, |
| | or high temperature materials |

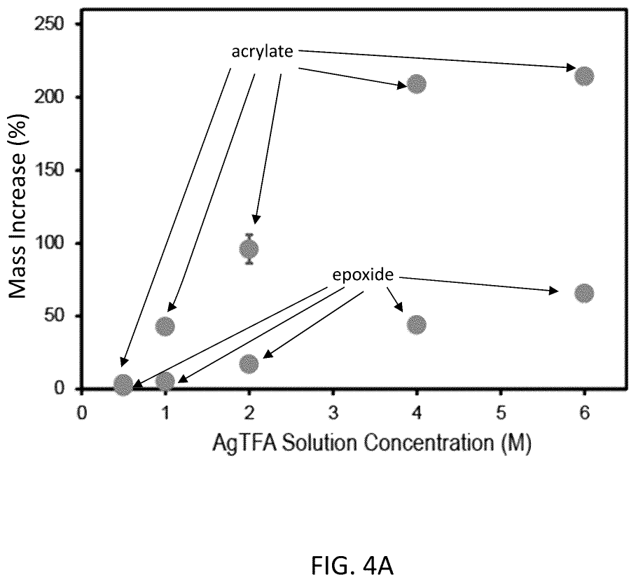

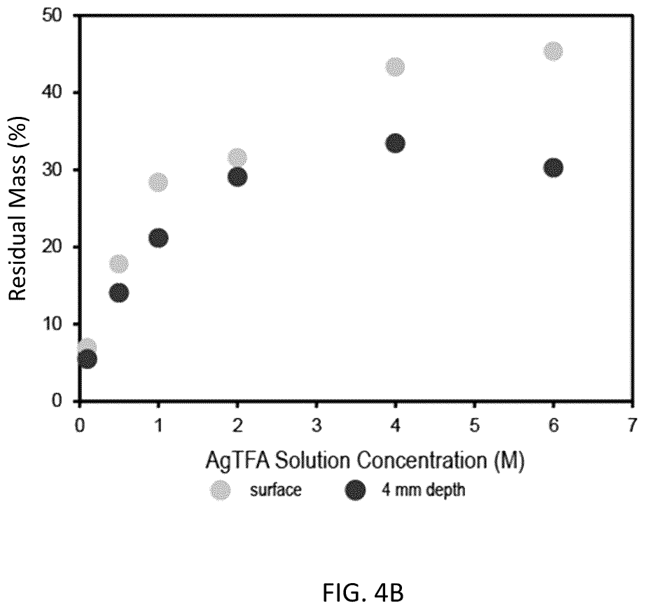

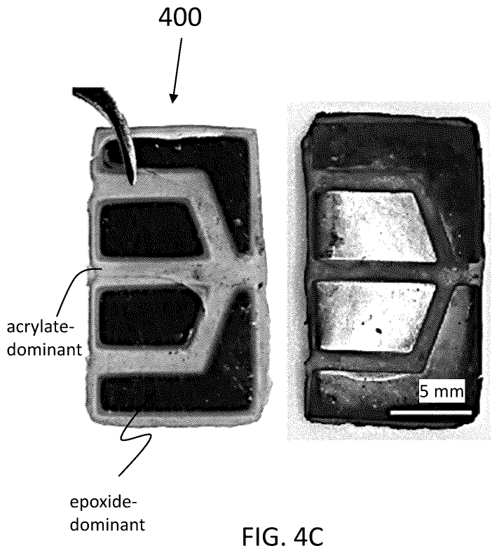

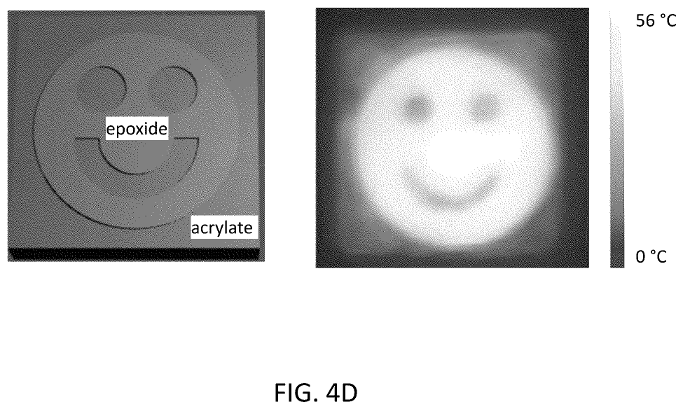

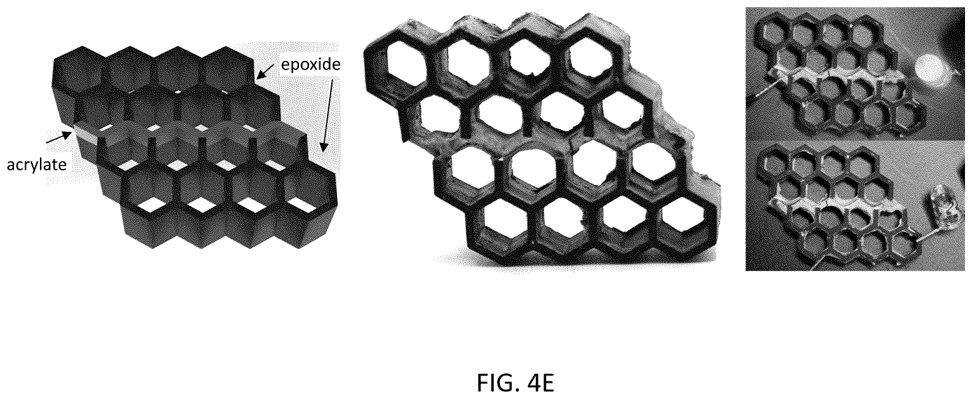

Various amounts of the infusion material may be included in the infusion solution, depending upon the desired amount of infusion material present in the selected region of the fabricated object. (See FIG. 4A.) The conditions under which exposure to the infusion solution occurs (e.g., temperature, period of time, atmosphere) may be selected to facilitate selective incorporation of the infusion material into the fabricated object. Illustrative conditions are provided in the Example, below. Further regarding selective incorporation, the amounts of the infusion material in the infusion solution and/or the exposure conditions may be selected such that the two regions of the fabricated object exhibit a desired concentration (or amount) ratio, i.e., (concentration of infusion material in one of first and second regions)/(concentration of infusion material in the other of first and second regions). This ratio may be at least 2, at least 5, at least 10, or at least 15. This includes ranges between any of these values. Embodiments are encompassed in which the concentration or amount of infusion material in one of the first and second regions is zero, too small to be measurable, or too small to materially affect a certain property of the region (e.g., its conductance).

A single type of infusion material or multiple, different types of infusion materials may be used in the infusion solution. The present methods may comprise multiple exposure steps, including a first exposure step to incorporate a first type of infusion material into one of the first and second regions of the fabricated object and a second exposure step to incorporate a second, different type of infusion material into the other of the first and second regions.

The present methods further comprise removing the swelling solvent from the infused fabricated object. This may be accomplished by exposing the infused fabricated object to conditions under which the swelling solvent evaporates therefrom. Illustrative conditions are provided in the Example, below.

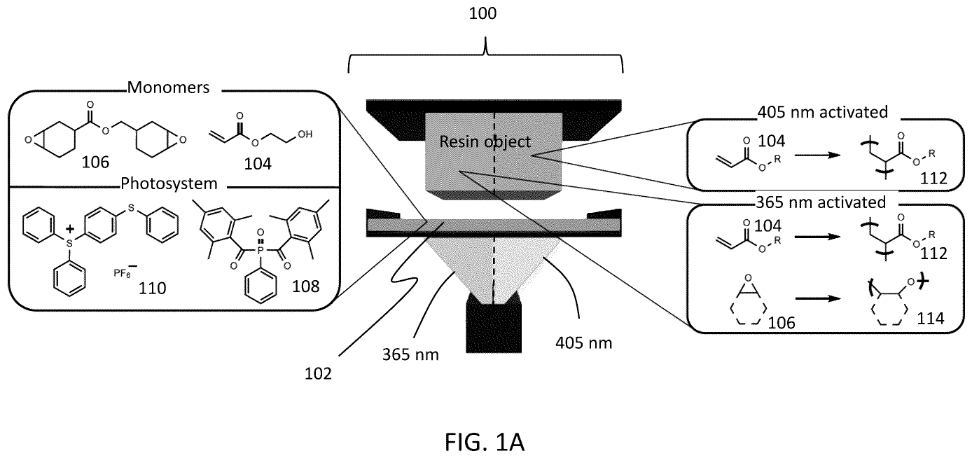

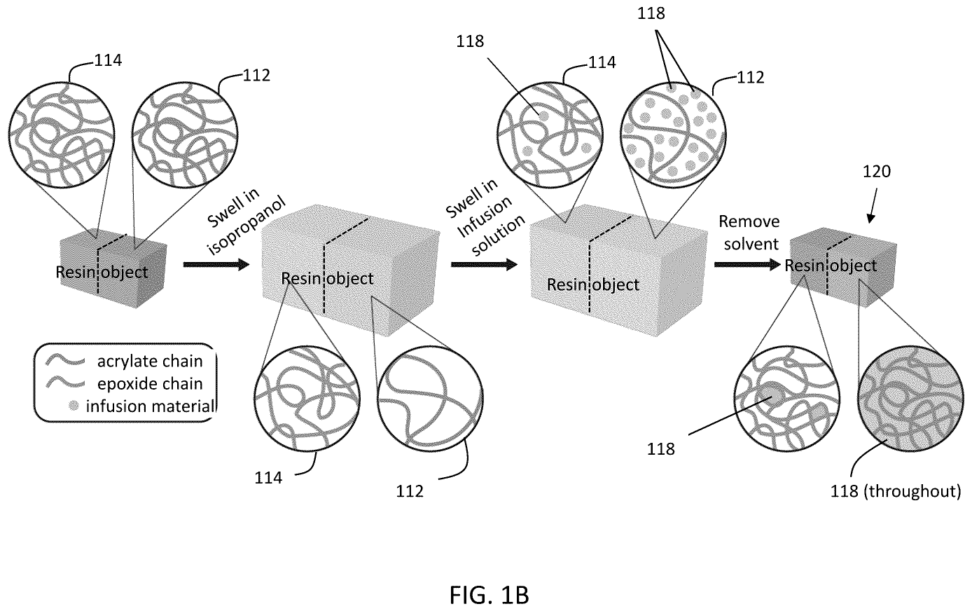

An illustrative embodiment of the present methods is schematically illustrated in FIGS. 1A-1B. FIG. 1A shows a curable composition 102 provided within a vat of a dual wavelength additive manufacturing system 100. As shown in the left image, the curable composition 102 includes both acrylate prepolymers 104 and epoxide prepolymers 106 along with initiators 108, 110 that induce polymerization reactions between acrylate prepolymers and between epoxide prepolymers, respectively. As shown in the right image, the dual wavelength additive manufacturing system 100 is configured to illuminate localized regions of the curable composition with 405 nm light, generating polyacrylate networks 112 therein. It is also configured to illuminate localized regions with 365 nm light, which can generate both polyacrylate networks 112 and polyepoxide networks 114 therein, with the relative amounts depending upon the other illumination conditions used.

FIG. 1B shows a fabricated resin object formed using the dual wavelength additive manufacturing system 100. The fabricated resin object has two distinct regions, including one composed of a polyepoxide network 114 (left) and one composed of a polyacrylate network 112 (right). The fabricated resin object is exposed to a solvent (e.g., isopropanol) to remove unreacted monomers therefrom; not shown is a subsequent step in which this solvent is removed from the fabricated resin object, e.g., by drying. (Any of the embodiments of the present methods may include these steps.) Next, the fabricated resin object is exposed to an infusion solution composed of a swelling solvent and an infusion material 118. Due to the different swelling behaviors of the polyepoxide network 114 and the polyacrylate network 112, a greater amount of the infusion material 118 is incorporated into the polyacrylate network 112 as compared to the polyepoxide network 114 (i.e., the infusion material 118 is selectively infused into the fabricated resin object). As also shown in FIG. 1B, the swelling solvent is removed from the infused fabricated resin object to provide a multimaterial resin object 120 composed of the polyepoxide network 114, the polyacrylate network 112, and the infusion material 118 distributed throughout the polyacrylate network 112. A greater amount of the infusion material 118 is present in the polyacrylate network 112 as compared to the polyepoxide network 114.

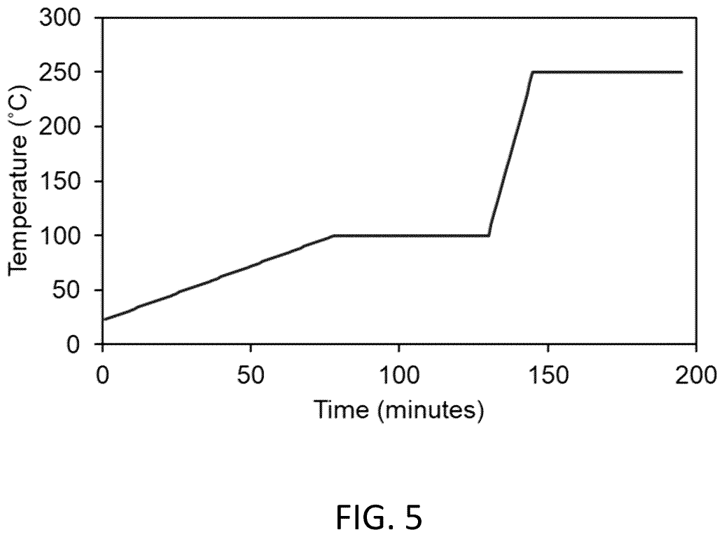

The present methods may include additional steps. An illustrative such step involves converting the infusion material within the fabricated multimaterial object to a different form. By way of illustration and as demonstrated in the Example, below, selective infusion of a metal salt, e.g., a silver salt, into a fabricated resin object results in the selective incorporation of silver cations into specific regions therein. Subsequent exposure to heat for a period of time reduces the silver cations present in those specific regions to silver metal, which is both electrically and thermally conductive. As another example, selective infusion of silicone prepolymers and a curing agent into a fabricated resin object results in the selective incorporation of these components into specific regions therein. Subsequent exposure to heat for a period of time cures the silicone prepolymers to a secondary polysilicone network. These types of thermal treatment steps are mild and thus, do not chemically alter the composition of the various regions of the fabricated resin object. For example, the temperatures used may be no greater than 500° C., no greater than 450° C., no greater than 400° C., no greater than 350° C., no greater than 300° C., or no greater than 250° C., including a range between any of these values. An illustrative heating profile that may be used to thermally treat a multimaterial object to convert silver cations therein to silver metal is shown in FIG. 5.

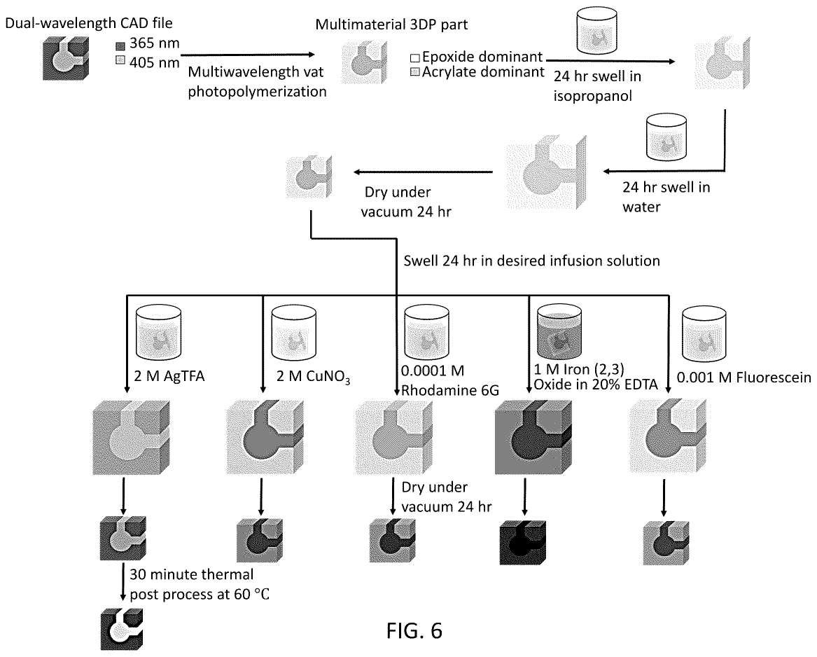

FIG. 6 is a flow chart schematically illustrating various embodiments of the present methods.

The present disclosure encompasses the multimaterial objects fabricated using any of the present methods. Illustrative multimaterial resin objects are shown in FIGS. 2B, 2C, and FIG. 4C. Regarding FIG. 4C, the images are of a multimaterial object 400 fabricated using the illustrative method shown in FIGS. 1A-1B. The object 400 is composed of a polyacrylate region configured with three prongs, each of which is surrounded on its sides by a complementary shaped polyepoxide region. The left image shows the multimaterial object 400 after selective infusion of a silver salt into the polyacrylate region. The right image shows the object 400 after thermal treatment to convert the silver cations in the polyacrylate region to silver metal, rendering this region and its three prongs electrically conductive. This is demonstrated by experiments described in the Example below showing that the polyacrylate region having the silver metal distributed throughout completes a circuit with a battery and an LED light. The experiments also show that the polyepoxide region is sufficiently free of the silver metal such that it remains electrically insulating. (See also FIG. 4E showing that only the central silver-infused polyacrylate region in the honeycomb patterned part structure completes a circuit and not the surrounding polyepoxide regions on either side.)

In fact, the present methods may be used to fabricate multimaterial objects having metal (e.g., silver)-infused polymeric (e.g., polyacrylate) regions that are electrically conductive (e.g., exhibiting an electrical conductivity of 4000 S/m or greater) and polymeric (e.g., polyepoxide) regions that are electrically insulating (e.g., exhibiting an electrical conductivity of 0.000001 S/m or less). Such electrically insulating regions may be characterized as being metal-free since the amount of any metal in such regions is too small to material affect the conductance of the regions. Thus, the present disclosure encompasses electrical circuits comprising one or more conductive regions comprising a first polymeric network and a conductive material (e.g., metal) distributed throughout, and one or more insulating regions comprising a second polymeric network. The one or more conductive regions may be separated from one another by the one or more insulating regions, e.g., by being surrounded or embedded by the one or more insulating regions. Also encompassed are devices comprising such electrical circuits, e.g., a sensor.

Another application of the present methods includes enabling fabrication and subsequent removal of support structures from a desired object. In such an application, the present methods may be used to fabricate the desired object and its support structures followed by selectively infusing an infusion material into either the support structures or the desired object such that the support structures, but not the desired object, are rendered removable (e.g., dissolvable) in a post-processing step.

The multimaterial objects fabricated using the present methods include components configured for use in various energy storage devices such as batteries, e.g., electrodes, membranes, and solid electrolytes. Such components are also encompassed.

The multimaterial objects fabricated using the present methods include metamaterials, i.e., objects comprising repeating structural elements configured to interact with particular waves (e.g., electromagnetic) in a particular way (e.g., focusing). In such metamaterials, the at least two regions (one of which has more infusion material distributed throughout as described herein) differ from each other at least by having different densities. Densities of the regions may be determined by measuring the volume and mass of each of the regions independently. The magnitude of the difference in densities may be quantified as a density ratio, i.e., (density of region(s) having greater density)/(density of region(s) having smaller density). In embodiments, the density ratio of the at least two regions is at least 2, is at least 5, at least 7, at least 10, a range of from 1.23 to 10, or a range between any of these values. Regions having different densities may be achieved by one of the regions comprising a first type of polymeric network and a metal distributed throughout and the other of the regions comprising a second type of polymeric network free of the metal. For example, the silver-infused polyacrylate-dominant regions of the multimaterial object of FIG. 4C have a greater density than the silver-free polyepoxide-dominant regions of the multimaterial object. The density ratio for the multimaterial object of FIG. 4C is about 2 to 1. Instead of the prong pattern shown in FIG. 4C, the polyacrylate-dominant regions and the polyepoxide-dominant regions may be patterned so that the multimaterial object functions as a metamaterial. That is, the pattern may be configured such that the multimaterial object is capable of interacting with (e.g., focusing) light waves or sound waves. This may be achieved by the polyacrylate-dominant regions and the polyepoxide-dominant regions having appropriate shapes, dimensions, and arrangements that correspond to the types of subwavelength structures present in existing metamaterials

### EXAMPLE

### Introduction

This Example describes experiments using a VP-based AM technique, coined infusion multimaterial actinic spatial control additive manufacturing (iMASC-AM), which involves the application of wavelength-specificity to dictate material composition with spatial resolution that is determined by which wavelength(s) of light are applied to which volumes of the printed part (FIG. 1A). Since material compositions can be differentiated, physicochemical properties (e.g., swelling ratios) can therefore also be controlled along all three axes. An integrated workflow is presented that enables selective infusion to specific volumes of a 3-dimensional (3D) part produced via MASC-AM. The iMASC-AM technique is shown to combine the infusion solutes from a broad range of materials classes with the multimaterial spatial resolution of MASC (FIG. 1B).

### Materials and Methods

### Materials

2-Hydroxyethyl acrylate, 3,4-epoxycyclohexylmethyl-3,4-epoxycyclohexanecarboxylate, phenylbis(2,4,6-trimethylbenzoyl)phosphine oxide, silver trifluoroacetate, fluorescein, rhodamine 6G, tetrahydrofuran, and copper (II) nitrate hemi (pentahydrate) were purchased from Sigma-Aldrich. Epoxycyclohexyl ethyl functionalized polyhedral oligomeric silsesqioxane cage mixture (30% in 3,4-epoxycyclohexylmethyl-3,4-epoxycyclohexanecarboxylate) was purchased from Hybrid Plastics. Hydroquinone (99.5%) was purchased from Acros Organics. 2-Propanol was purchased from Fisher Scientific. SYLGARD® 184 silicone elastomer base and curing agent were purchased from Dow.

### Resin Formulation

25 mL 2-Hydroxyethyl acrylate, 20 mL 3,4-epoxycyclohexylmethyl-3,4-epoxycyclohexanecarboxylate, 0.2 g phenylbis(2,4,6-trimethylbenzoyl)phosphine oxide, 0.06 g hydroquinone, 1.75 mL epoxycyclohexyl ethyl functionalized polyhedral oligomeric silsesqioxane cage mixture (30% in 3,4-epoxycyclohexylmethyl-3,4-epoxycyclohexanecarboxylate), and 6 mL triarylsulfonium hexafluoroantimonate salts (50 weight % in propylene carbonate) were added to an amber borosilicate vial in the specified amounts (order of addition is not important). The resin was stirred in the dark at room temperature for 24 hours before manufacturing.

### Additive Manufacturing Step

Multimaterial parts were printed using a custom-built dual-wavelength vat photopolymerization printer (see below). Epoxide-dominant regions were irradiated with UV light for 75 s per 0.1 mm layer. Acrylate-dominant regions were irradiated with white light for 15 s per 0.1 mm layer. After printing, multimaterial parts were soaked in isopropanol for 24 hr to remove unreacted monomer, then dried under vacuum for 24 hr.

### General Multimaterial Infusion Step

Silver trifluoroacetate, copper nitrate, and rhodamine 6G infusions: 2, 2, and 0.00001 M solutions of silver trifluoroacetate, copper nitrate, and rhodamine 6G, respectively, were prepared in deionized water. Printed parts were swelled in infusion solutions for 12 hours, then dried under vacuum at room temperature for 24 hours.

### Thermal Processing of Silver Trifluoroacetate Infused Multimaterial Parts

1° C./min to 100° C., then held at 100° C. for 60 minutes. They were then heated at a rate of 10° C./min to 250° C., then held at 250° C. for 60 minutes.

### Silicone Infusion

SYLGARD™ 184 elastomer base was mixed with SYLGARD™ 184 curing agent in a 10:1 ratio, respectively. This mixture was dissolved in 1:1 isopropanol: tetrahydrofuran (10% v/v). Printed parts were swelled in the SYLGARD™ 184 solution for 24 hours and then dried under vacuum at room temperature for 24 hours. The dry parts were thermally cured at 120° C. for 2 hours.

### Nuclear Magnetic Resonance

The uncured resin sample was packed in a Bruker 4-mm HRMas sample holder inside a ZrO₂ rotor. The cured parts were frozen in liquid nitrogen and ground with magnesium oxide. These were weighed into 4-mm Doty pencil rotors with glass filled torlon caps. The 13C cross-polarized (CP) MAS NMR spectra were obtained using an Avance III Bruker instrument using a 4-mm broadband MAS probe at a resonant frequence of 125.79 and 500.22 MHz for 13 C and 1H, respectively. Each sample used high power (100 kHz) 1H Spinal 64 decoupling, a 3 s recycle delay. A 1.2-ms contact time employing a 70-100% ramped shape on the 1H channel. For the resin sample a 5 kHz spinning speed and 18 k scan averaging was used. For the visible light-irradiated sample an 11 kHz spinning speed and 16 k scans was employed, whereas for the UV light-irradiated sample an 8 kHz spinning speed and 20 k scan averaging was used. The number of scans varied for the length of time available for the experiments in a shared use facility, and the spinning speed was the maximum attainable with the individual rotor.

### Instrumentation

Dual Wavelength Vat Photopolymerization: Dual wavelength 3D printing was done on a custom 3D printer equipped with an Acer X152H visible light projector and a PDCO5-5 365 nm light projector purchased from Xiamen Zhisen Electro. Equip. Co., LTD. Print files were prepared in MATLAB. MATLAB was used to run the printer by controlling projectors via Psychtoolbox and sending G code commands via the serial port.

Thermogravimetric Analysis: TGA was conducted on a TA Instruments Q50 thermogravimetric analyzer under air.

Scanning Electron Microscopy/Energy Dispersive X-Ray Spectroscopy: SEM and EDX were conducted on a Zeiss Gemini SEM 450 at an accelerating voltage of 5 kV.

Tensile Analysis: Tensile analysis was conducted on a MTS Criterion Electromechanical Testing System using ASTM D638 type V specimens. The strain rate was set to 0.1 mm/s and 0.8 mm/s for epoxide and acrylate-dominant materials, respectively. Tensile strain of acrylate-dominant materials was measured through video analysis by counting the change in the number of pixels of the gauge region.

Contact Angle Measurements: Contact angle measurements were performed on a Dataphysics OCA 15EC Optical contact angle goniometer. A dosing volume of 4 μL, dosing rate of 1 μL/s, DS 500/GT (500 μL) syringe, and SNS 050/026 syringe were used.

Viscosity Measurements: Viscosity measurements were performed on a TA Instruments HR 20 rheometer. Experiments were performed at 25° C. with a 90-s soak time. Data was collected between shear rates of 10 and 1000 1/s with 5 points per decade, 5-s equilibration time, and 30-s averaging time.

Conductivity Measurement: Bulk resistance was measured with a Hewlett Packard 33401A Multimeter. Conductivity was calculated using the equation σ=L/(SR), where L is the distance between electrodes, S is the cross-sectional area of the sample, and R is the bulk resistance.

### Results

### Infusion of Multimaterial Parts

As illustrated in FIG. 1A, MASC-AM uses a single resin formulation containing, for example, epoxide monomers and a photoacid generator, as well as acrylate monomers and a photoradical initiator. The resin is 3D printed via dual-wavelength vat photopolymerization. In design, this printer is capable of patterning light at single-pixel resolution (approximately 45 μm²). In practice, patterned features are visually discernable down to 50 μm resolution (data not shown). In regions exposed to UV light, the photoacid generator is activated which primarily drives the cationic polymerization of epoxide monomers. In contrast, in regions where visible light is applied, the photoradical initiator is activated, which results in selective curing of the acrylate monomers (data not shown). The dual photochemical mechanistic approach of MASC is complementary to multimaterial VP that leverages greyscale light projection to accomplish spatially resolved degrees of crosslinking of the same resin monomers throughout the part, or approaches that implement a two-stage curing procedure in which one resin is thermally cured after the AM process is completed.

As illustrated in FIG. 1B, the present Example describes a new technique (iMASC AM) that leverages the disparate swelling profiles of epoxide- and acrylate-dominated regions to selectively infuse material within a patterned domain of a multimaterial part. Different solvents were evaluated and the swelling ratios of epoxide- and acrylate-dominated regions were assessed. Across all solvents screened, the acrylate-dominant regions gave greater swelling percentages (determined gravimetrically) than did the epoxide-dominant regions (FIG. 2A). For example, when soaked in isopropanol, the epoxide- and acrylate-dominant regions experienced 5% and 14% increases in mass, respectively. It was found that when soaked in water the mass changes were more dramatic, achieving 15% mass increase for epoxide-dominant regions versus 130% for acrylate-dominant regions. Toluene was the least effective solvent for swelling the parts, increasing the mass of the epoxide- and acrylate-dominant domains by just 0.8% and 1.5%, respectively. The most effective solvent for swelling, as judged by the ratio of swelling percentages, was a 1:1 v/v solution of water and isopropanol (IPA) which increased the mass of the epoxide- and acrylate-dominant domains by 40% and 532%, respectively.

These initial results led to the investigation of the applicability of the hydrogel infusion technique across different materials (summarized in FIGS. 2B-2D). Organic dyes, such as rhodamine 6G, were readily infused into the printed parts. By keeping the concentration of the dye in the aqueous medium very low (e.g., <1 μM), it was possible to visually observe the effects of selective swelling in the patterned part (FIG. 2B). Similarly, selective infusion was also visually observable with high concentration (≥2 M) infusion solutions of metal salts, such as copper (II) nitrate (FIG. 2C). The acrylate-dominant regions experience an approximately 50% volume increase after infusion with high concentration (≥2 M) solutions due to the added volume of the infusion material, bringing the visually-discernable feature resolution to 100 μm (data not shown). Additionally, chemically distinct resin precursors, such as silicones, were successfully infused and later thermally cured to give rise to three-component multimaterial parts (FIG. 2D).

### Infusion of Silicone Precursors

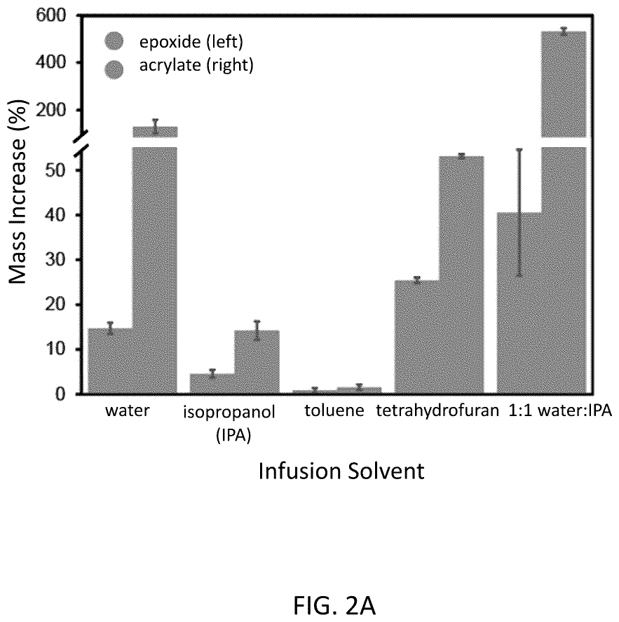

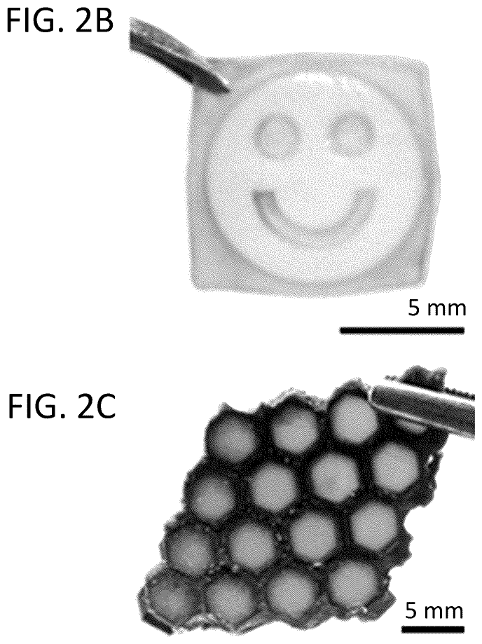

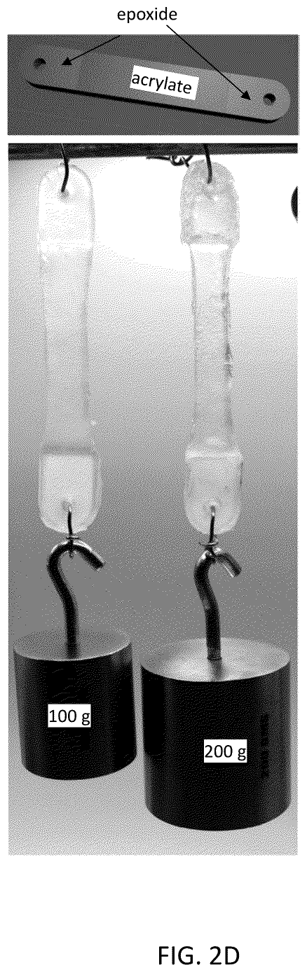

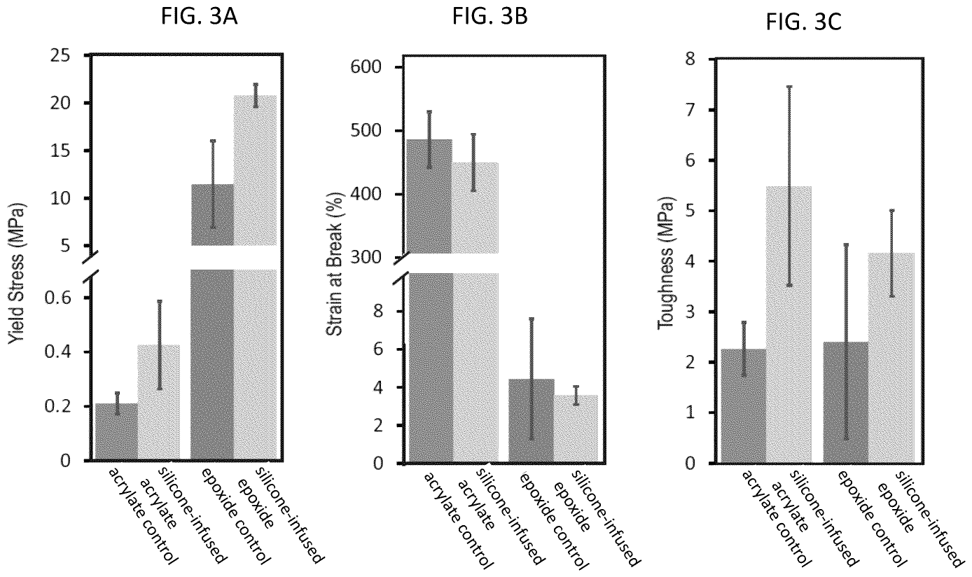

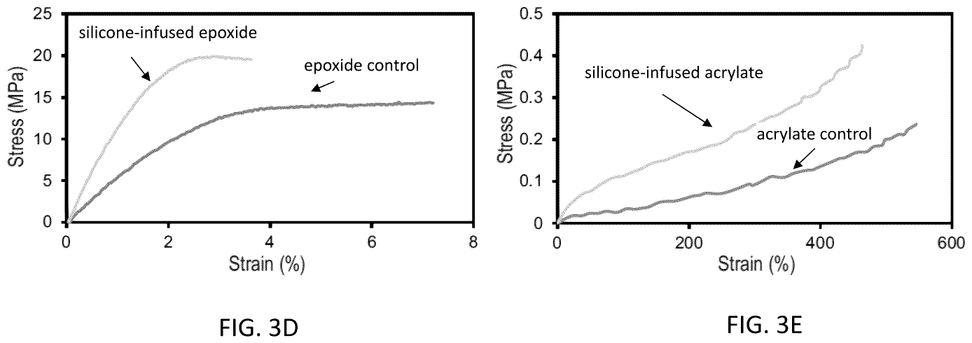

In general, incorporation of Pt-cured silicones into vat-based AM, let alone multimaterial AM processes, is challenging. A set of experiments were conducted to evaluate whether patterned silicone multimaterial parts could be fabricated. Toward this end, SYLGARD™ 184 elastomer precursors dissolved in 1:1 v/v IPA and tetrahydrofuran (THF) were infused into the multimaterial parts for 24 hours. As a technical note, assessments of the infusion kinetics over time suggested that increased infusion time may lead to a greater mass of infused silicone monomers (data not shown). After infusion, the parts were then treated in an additional thermal post-processing step at 120° C. for 120 minutes to thermally cure the silicone networks via Pt-catalyzed hydrosilylation. Subsequent uniaxial tensile testing was found to be consistent with successful formation of the silicone secondary network (data not shown). The effects were observed to differing extents across both epoxide- and acrylate-dominant parts. Specifically, tensile test specimens were prepared using either UV or visible light. Each was then subjected to infusion and thermal post-curing before tensile testing (FIGS. 3A-3E). On average, the epoxide-dominant parts experienced an 82% increase in yield stress (from 11.4 to 20.8 MPa, FIG. 3A) and no significant change in strain at break or toughness (defined here as strain energy density, FIGS. 3B and 3C, respectively). On average, the acrylate dominant parts experienced a 105% increase in yield stress (from 0.21 to 0.43 MPa, FIG. 3A), no significant change in strain at break (FIG. 3B), and a 279% increase in toughness (from 0.52 to 4.16 MPa, FIG. 3C). When subjected to cyclic tensile loading to 50% of maximum strain, the parent acrylate-dominant material failed after 7 cycles, whereas the silicone-infused acrylate-dominant sample underwent 110 cycles without failure, indicating increased reversible deformation behavior of the silicone-infused material consistent with silicone network formation (data not shown).

The silicone infusion significantly increased the tensile strength of both domains (FIGS. 3A, 3D, and 3E), increased the toughness of the acrylate-dominant domain (FIGS. 3C and 3E), and maintained notable disparity between the two material regions. Additionally, the percentage increase of each mechanical property of the acrylate-dominant parts was found to be greater than that of the epoxide-dominant parts. These results are consistent with the nature of the infusion behavior of the two materials and reflect the fact that the epoxide-dominant parts begin as a stiffer material than the polyacrylate parts.

Finally, to illustrate the multimaterial functionality of iMASC-AM, mechanical analysis was done on printed samples with alternating acrylate- and epoxide-dominant domains (data not shown). This demonstrated the ability to program one or more localized stress responses within a printed multimaterial part (data not shown). After infusion, the multimaterial parts showed increased strength and toughness which is consistent with previous, single-material silicone-infusion results (data not shown).

### Infusion of Metal Salts

Next, experiments were conducted to evaluate the incorporation of inorganic species, with particular interest in those that could ultimately lead to spatially resolved metallic and electrically conductive patterns. Multimaterial AM combining materials of different classes (e.g., thermoplastics, thermosets, and metals), has historically been challenging to realize due to drastically different processing requirements and chemical incompatibilities across the different components. Notably, techniques that are commonly used for AM of metal parts tend to be destructive to organic components.

It was found that both copper (II) nitrate and silver (I) trifluoroacetate (AgTFA) were efficiently incorporated into acrylate-dominant regions during the infusion process. Spatial control of the Cu(NO₃)₂ infusion was easily discernable due to its deep blue color, indicating greater extent of infusion into the acrylate-dominant regions than the epoxide-dominant regions (FIG. 2D). Acrylate-dominant domains displayed a 156% increase in mass when infused with 2 M Cu(NO₃)₂ solution, compared to a 13% mass increase in the epoxide-dominant domains (data not shown), after removal of volatiles.

Similar success was achieved with the selective infusion of aqueous AgTFA. Silver is a particularly interesting infusion material since silver-infused parts can be rendered electrically conductive via comparatively milder thermal post-processing. To explore the AgTFA infusion in more detail, a concentration range of 0.1 to 6 M was assessed. FIG. 4A shows that a monotonic increase in the percentage change in mass as the concentration of AgTFA in the infusion solution was increased. At AgTFA concentrations greater than 2 M, however, salt precipitation on the surface was apparent. Salt precipitation on the part surface was also observable after long infusion times (>48 hours). The infusion of 1 M AgTFA resulted in an average mass increase in the acrylate- and epoxide-dominant areas of 59% and 11%, respectively (data not shown), corresponding to a AgTFA concentration in the network of approximately 2.20 and 0.59 M, respectively. The optimal infusion time for 2 M AgTFA was found to be 24 hours, as infusion kinetics experiments showed a stabilization of mass change due to infusion between 12 and 24 hours (data not shown). Thermogravimetric analysis of acrylate-dominant domains infused with 2 M AgTFA showed similar residual mass from specimens collected from the part surface as those collected at 4 mm below the surface, indicating the infusion solution effectively penetrates the part (FIG. 4B).

Importantly, post-processing of silver-infused materials to achieve conductivity can be achieved via thermal processing at temperatures low enough to avoid thermal decomposition of organic networks. Encouraged by the prospects of patterned conductive and insulating domains within a single 3D part, next, thermally induced reduction of the AgTFA in parts produced via iMASC was carried out (FIG. 4C). After mild thermal processing (≤200° C., data not shown) it was found that the acrylate-dominant domains (high silver content) showed fast heat dissipation indicative of high thermal conductivity (FIG. 4D), and electrical conductivity between 4235 and 42 S·m⁻¹. In contrast the epoxide-dominant regions showed slower heat dissipation (FIG. 4D) and electrical conductivity less than 2×10⁻⁵ S·m⁻¹ after the same thermal processing. It was found that simple circuit designs could be achieved via iMASC. For example, the silver-infused, thermally reduced acrylate-dominant domains were capable of completing a circuit with a 9-V battery to power an LED (FIG. 4E and other data not shown). The equivalent epoxide-dominant domain did not complete a circuit.

To determine the print parameter threshold for achieving conductive or insulating domains, the effects of UV exposure on conductivity outcomes was examined. In the resin system used for these prints, UV light initiated the epoxide polymerization at high exposure and the acrylate polymerization at low exposure. It was found that parts irradiated with UV light for 15 s or less showed electrical conductivity measurements consistent with acrylate-dominant material and parts irradiated with UV light for 25 s or more showed electrical conductivity measurements consistent with epoxide-dominant material (data not shown). This can likely be attributed to a stark difference in swelling behavior between samples that experience 15 and 25 s of UV irradiation (data not shown). The irradiation time required to create insulating domains (25 s) is significantly less than is required to achieve the mechanical properties typical of an epoxide-dominated material in the MASC setup (75 s). This finding indicates that even low conversion of epoxide is enough to create insulating domains in the final infused part, suggesting print times for these multimaterial parts could be significantly shorter than print times traditionally required for epoxide vat photopolymerization, while still achieving spatially resolved conductive and insulation regions.

### Discussion

The development of iMASC-AM offers a pivotal advancement in achieving multimaterial 3DP capabilities through multiwavelength VP by eliminating the need for complex reformulation of wavelength-specific resin chemistries. The MASC-AM product is a divergent intermediate that can be used to create a variety of materials combinations via iMASC-AM. By leveraging wavelength-selective acrylate and epoxide polymerizations, this Example demonstrated that regions of a printed object can be spatially patterned to allow for disparate amounts of infusion of a secondary material. This selective infusion greatly expands the material scope for multiwavelength VP, allowing access to opaque, thermally-responsive, or viscous materials that are challenging to process through VP. The iMASC-AM approach enables fabrication of a wide variety of chemically diverse multimaterial architectures through a single streamlined printing process.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity.

Unless otherwise indicated, the term “type” as used herein refers to chemical formula such that a single type means the same chemical formula and different type means different chemical formula. Similarly, use of “more” as in “one or more” refers to use of different types of the relevant entity.

Throughout the present disclosure, terms such as “comprising” and the like may be replaced with terms such as “consisting” and the like.

What is claimed is:

1. A method of fabricating a multimaterial object, the method comprising:
(a) fabricating an object comprising a first region and a second region, the first region and the second region differing in their swelling behavior in an infusion solution comprising a swelling solvent and an infusion material dissolved therein;
(b) exposing the fabricated object to the infusion solution to form an infused fabricated object; and
(c) removing the swelling solvent from the infused fabricated object to form a multimaterial object comprising the first region, the second region, and the infusion material, wherein more infusion material is distributed throughout one of the first region and the second region than the other.

2. The method of claim 1, wherein the first region is one of a set of first regions and the second region is one of a set of second regions.

3. The method of claim 1, wherein the first region is a first type of polymeric network and the second region is a second type of polymeric network different from the first type of polymeric network.

4. The method of claim 1, wherein step (a) comprises inducing chemical reactions between prepolymers within a localized area of a curable composition to form a polymeric network in the localized area, the curable composition comprising prepolymers.

5. The method of claim 4, wherein the chemical reactions are induced by light, heat, or both.

6. The method of claim 1, wherein step (a) comprises fabricating the object via an additive manufacturing technique.

7. The method of claim 1, wherein the first and second regions are characterized by a swelling ratio of at least 2.

8. The method of claim 1, wherein step (a) comprises fabricating the object from a curable composition comprising a first type of prepolymer and a second type of prepolymer different from the first type of prepolymer.

9. The method of claim 8, wherein the first type of prepolymer is a (meth)acrylate prepolymer and the second type of prepolymer is an epoxide prepolymer.

10. The method of claim 1, wherein the swelling solvent is selected from water, an alcohol, tetrahydrofuran, a terpene, and combinations thereof.

11. The method of claim 1, wherein the infusion material is selected from metal salts, dyes, metal oxides, prepolymers, polymers, and combinations thereof.

12. The method of claim 1, wherein the infusion material is a silver salt.

13. The method of claim 1, wherein at least 2 times more infusion material is distributed throughout one of the first region and the second region than the other.

14. The method of claim 1, further comprising step (d) converting the infusion material in the multimaterial object to a different form.

15. The method of claim 14, wherein the infusion material comprises metal cations and the different form comprises reduced metal.

16. The method of claim 14, wherein the converting is carried out by heating the multimaterial object.

17. The method of claim 16, wherein the heating uses a temperature of no greater than 500° C.

18. A multimaterial object comprising one or more electrically conductive regions comprising a first type of polymeric network and an electrically conductive material distributed throughout; and one or more electrically insulating regions comprising a second type of polymeric network.

19. The multimaterial object of claim 18, wherein the electrically conductive material comprises metal atoms.

20. The multimaterial object of claim 19, wherein the one or more electrically insulating regions surround the one or more electrically conductive regions.
